(19) United States
(12) Patent Application Publication
(10) Pub. No.: US 2025/0097326 A1
(43) Pub. Date: Mar. 20, 2025

(54) WIRELESS COMMUNICATION METHOD AND DEVICE THEREOF

(71) Applicant: ZTE Corporation, Shenzhen (CN)

(72) Inventors: Xiubin SHA, Shenzhen (CN); He HUANG, Shenzhen (CN); Zhuang LIU, Shenzhen (CN); Bo DAI, Shenzhen (CN); Yin GAO, Shenzhen (CN); Ling XU, Shenzhen (CN); Zhihong QIU, Shenzhen (CN); Yuan GAO, Shenzhen (CN)

(21) Appl. No.: 18/961,300

(22) Filed: Nov. 26, 2024

Related U.S. Application Data
(63) Continuation of application No. PCT/CN2022/103091, filed on Jun. 30, 2022.

(51) Int. Cl. H04L 69/28; H04W 24/08

(52) U.S. Cl. CPC H04L 69/28; H04W 24/08

(57) ABSTRACT

A wireless communication method for use in a wireless terminal is disclosed. The method comprises performing, with a wireless network node, a data communication, wherein time information associated with the data communication and a time information identification of the time information are included in a Packet Data Convergence Protocol (PDCP) packet data unit (PDU) of the data communication.

### CROSS-REFERENCE TO RELATED APPLICATION

This application is a continuation of International Patent Application No. PCT/CN2022/103091, filed on Jun. 30, 2022, the disclosure of which is incorporated herein by reference in its entirety.

### FIELD

This document is directed generally to wireless communications and in particular to 5G communications.

### BACKGROUND

In some cases, per packet delay may be necessary:

Case 1: Deterministic delay guarantee:

The deterministic delay may be guaranteed only for periodic traffics with large traffic interval. For example, based on a burst arrive time of a first packet at a 5G system (5GS) ingress and a periodicity, a reception entity may decide the burst arrive time of each packet at the 5GS ingress. Based on the packet delay budge (PDB), a 5GS outgress can determine a burst forwarding time (e.g. if the packet arrives the 5GS outgress earlier, the 5GS outgress will hold and forward the packet until the burst forwarding time). However, for a non-periodic service, the 5GS outgress cannot acquire the burst arrive time of each packet at the 5GS ingress, thus cannot know the burst forwarding time. Furthermore, for a small traffic interval, the 5GS outgress cannot determine the burst forwarding time for packet retransmissions over Uu interface (e.g. the arriving packets at 5GS outgress may be out of order, the packet sent earlier may arrive in the 5GS outgress later). If the 5GS outgress cannot determine the burst arrive time of each packet at the 5GS ingress, the 5GS outgress cannot know the packet forwarding time at the 5GS outgress.

Case 2: for precise network performance evaluation (e.g. service level agreement (SLA)), per packet delay information is also useful.

However, how to acquire the per packet delay between a user equipment (UE) and gNB remains unknown.

### SUMMARY

This document relates to methods, systems, and devices for per packet delay determination and in particular to methods, systems, and devices for per packet delay determination between the UE and gNB.

The present disclosure relates to a wireless communication method for use in a wireless terminal. The method comprises:
performing, with a wireless network node, a data communication, wherein time information associated with the data communication and a time information identification of the time information are included in a Packet Data Convergence Protocol (PDCP) packet data unit (PDU) of the data communication.

Various embodiments may for example implement the following features:

For example the time information associated with the data communication and the time information identification of the time information are included in a PDCP PDU header of the PDCP PDU.

For example performing, with the wireless network node, the data communication comprises: receiving, from the wireless network node, the PDCP PDU.

For example the time information identification indicates that the time information is a time of packet transmitting from a PDCP entity, a time of packet arriving at an upper service access point (SAP) of a PDCP entity of the wireless network node, a time of packet arriving at a PDCP entity, a time of packet arrival at a 5G system (5GS) ingress, or a time of packet arrival at a user plane function (UPF).

For example performing, with the wireless network node, the data communication comprises: transmitting, to the wireless network node, the PDCP PDU.

For example the time information identification indicates that the time information is a time of the wireless terminal receiving the PDCP PDU.

For example the time information indicates a time by comprising:
a coordinated universal time (UTC)
a global positioning system (GPS) time,
an elapsed time from a start of a day,
an elapsed time from a start of second of a reference time, or
an elapsed time from a start of millisecond of a reference time, wherein a unit of the milliseconds of the reference time is 20 milliseconds, and
wherein the unit of the time is one of quarter microsecond, microsecond, nanosecond or a multiple of nanosecond.

For example the wireless communication method further comprises reporting, to the wireless network node or a core network, a packet delay information report capability.

For example the packet delay information report capability comprises at least one of a DL packet delay report capability or a time information support indication in a PDCP header.

For example the packet delay information report capability is in an ATTACH REQUEST, a REGISTER REQUEST or a TRACKING AREA UPDATE REQUEST message.

For example the wireless communication method further comprises receiving, from the wireless network node or a core network, a packet delay information measurement indication.

For example the packet delay information measurement indication is received from a non-access stratum (NAS) message or in a radio resource control (RRC) message from the wireless network node.

For example the wireless communication method further comprises reporting, to the wireless network node or a core network, packet delay information.

For example the packet delay information is reported to the wireless network node in an RRC message or is reported to the core network in a NAS message.

For example the packet delay information comprises at least one of:
a packet delay list comprising packet delays of received DL packets,
the minimum DL packet delay,
the maximal DL packet delay, or
an average packet delay,
a DL packet delay of a received DL packet,
a DL data transmission time information of a received DL packet set by the wireless network node, or
a time information of the received DL packet arriving at the wireless network node.

For example the wireless communication method further comprises receiving, from the wireless network node or the core network, a request of reporting packet delay information.

For example the request indicates that the packet delay information is reported once in response to the request, reported periodically or reported if a condition is satisfied. For example the condition is that a packet delay is greater than a threshold.

For example the core network comprises a user plane function or an access and mobility management function.

The present disclosure relates to a wireless communication method for use in a wireless network node. The method comprises:

performing, with a wireless terminal, a data communication, wherein time information associated with the data communication and a time information identification of the time information are included in a Packet Data Convergence Protocol (PDCP) packet data unit (PDU) of the data communication.

Various embodiments for example implement the following features:

For example the time information associated with the data communication and the time information identification of the time information are included in a PDCP PDU header of the PDCP PDU.

For example performing, with the wireless terminal, the data communication comprises: transmitting, to the wireless terminal, the PDCP PDU.

For example the time information identification indicates that the time information is a time of packet transmitting from a PDCP entity, a time of packet arriving at an upper service access point (SAP) of a PDCP entity, of the wireless network node, a time of packet arriving at a PDCP entity, a time of packet arrival at a 5G system (5GS) ingress, or a time of packet arriving at a user plane function (UPF).

For example performing, with the wireless terminal, the data communication comprises: receiving, from the wireless terminal, the PDCP PDU.

For example the time information identification indicates that the time information is a time of the wireless terminal receiving the PDCP PDU.

For example the time information indicates a time by comprising:
a coordinated universal time (UTC)
a global positioning system (GPS) time,
an elapsed time from a start of a day,
an elapsed time from a start of second of a reference time,
an elapsed time from a start of millisecond of a reference time, wherein a unit of the milliseconds of the reference time may be 20 milliseconds,
wherein the unit of the time is one of quarter microsecond, microsecond, nanosecond or a multiple of nanosecond.

For example the wireless communication method further comprises:
reporting, to a core network, the time information and the time identification in an uplink, UL, PDU SESSION INFORMATION Format,
wherein the time information is indicated by a UL Sending Time information field, a UE PDCP Time information field or a 5GS Ingress Time information field in the UL PDU SESSION INFORMATION Format, which is identified by the time information identification.

For example the wireless communication method further comprises:
receiving, from a core network, the time information and the time information identification included in a downlink, DL, PDU SESSION INFORMATION format,
wherein the time information is indicated by a DL Sending Time information field or a 5GS Ingress Time information field in the DL PDU SESSION INFORMATION format which is identified by the time information identification.

For example the wireless communication method further comprises:
receiving, from the wireless terminal, a packet delay information report capability.

For example the packet delay information report capability comprises at least one of a DL packet delay report capability or a time information support indication in a PDCP header.

For example the wireless communication method further comprises:
reporting, to a core network, the packet delay information report capability.

For example the wireless communication method further comprises:
transmitting, to the wireless terminal, a packet delay information measurement indication.

For example the packet delay information measurement indication is in a radio resource control (RRC) message.

For example the wireless communication method further comprises:
receiving, from a core network, the packet delay information measurement indication.

For example the wireless communication method further comprises:
receiving, from the wireless terminal, packet delay information.

For example the packet delay information is in an RRC message.

For example the packet delay information comprises at least one of:
a packet delay list comprising packet delays of received DL packets,
the minimum DL packet delay,
the maximal DL packet delay, or
an average packet delay,
a DL packet delay of a received DL packet,
a DL data transmission time information of a received DL packet set by the wireless network node, or
a time information of the received DL packet arriving at the wireless network node.

For example the wireless communication method further comprises:
transmitting, to a core network, the packet delay information.

For example the wireless communication method further comprises:
transmitting, to the wireless terminal, a request of reporting packet delay information.

For example the request indicates that the packet delay information is reported once in response to the request, reported periodically or reported if a condition is satisfied.

For example the condition is that a packet delay is greater than a threshold.

For example the wireless communication method further comprises:
receiving, from a core network, the request of reporting the packet delay information.

For example the core network comprises a user plane function or an access and mobility management function.

The present disclosure relates to a wireless terminal. The wireless terminal comprises:
a communication unit, configured to perform, with a wireless network node, a data communication, wherein time information associated with the data communication and a time information identification of the time information are included in a Packet Data Convergence Protocol (PDCP) packet data unit (PDU) of the data communication.

Various embodiments for example implement the following feature:

For example the wireless terminal further comprises a processor configured to perform any of the aforementioned wireless communication methods.

The present disclosure relates to a wireless network node. The wireless network node comprises:
a communication unit, configured to perform, with a wireless terminal, a data communication, wherein time information associated with the data communication and a time information identification of the time information are included in a Packet Data Convergence Protocol (PDCP) packet data unit (PDU) of the data communication.

Various embodiments for example implement the following feature:

For example the wireless network node further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of the foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a Packet Data Convergence Protocol (PDCP) packet data unit (PDU) format according to an embodiment of the present disclosure.

FIG. 2 shows a schematic diagram of a PDCP PDU format according to an embodiment of the present disclosure.

FIG. 3 shows a schematic diagram of a Time Stamp format according to an embodiment of the present disclosure.

FIG. 4 shows a schematic diagram of a Time Stamp format according to an embodiment of the present disclosure.

FIG. 5 shows a schematic diagram of a Time Stamp format according to an embodiment of the present disclosure.

FIG. 6 shows a schematic diagram of a Time Stamp format according to an embodiment of the present disclosure.

FIG. 7 shows a schematic diagram of a Time Stamp format according to an embodiment of the present disclosure.

FIG. 8 shows a schematic diagram of a UL PDU SESSION INFORMATION Format according to an embodiment of the present disclosure.

FIG. 9 shows a schematic diagram of a UL PDU SESSION INFORMATION Format according to an embodiment of the present disclosure.

FIG. 10 shows a schematic diagram of a DL PDU SESSION INFORMATION (PDU Type 0) Format according to an embodiment of the present disclosure.

FIG. 11 shows a schematic diagram of a DL PDU SESSION INFORMATION (PDU Type 0) Format according to an embodiment of the present disclosure.

FIG. 12 shows a schematic diagram of a DL packet report procedure according to an embodiment of the present disclosure.

FIG. 13 shows a schematic diagram of a DL packet report procedure according to an embodiment of the present disclosure.

FIG. 14 shows a schematic diagram of a DL packet report procedure according to an embodiment of the present disclosure.

FIG. 15 shows a schematic diagram of a UL packet report procedure according to an embodiment of the present disclosure.

FIG. 16 shows an example of a schematic diagram of a wireless terminal according to an embodiment of the present disclosure.

FIG. 17 shows an example of a schematic diagram of a wireless network node according to an embodiment of the present disclosure.

FIGS. 18 to 20 show flowcharts of methods according to embodiments of the present disclosure.

### DETAILED DESCRIPTION OF EMBODIMENTS

In some embodiments, per packet delay between a base station (e.g. gNB) and a user plane function (UPF) may be determined based on a timestamp in a downlink (DL) protocol data unit (PDU) SESSION INFORMATION frame and/or an uplink (UL) PDU SESSION INFORMATION frame.

In the present disclosure, a method of per packet delay determination and corresponding embodiments are disclosed.

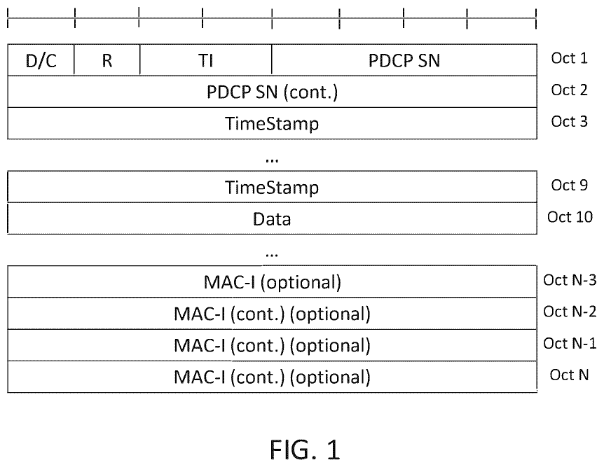

FIG. 1 shows a schematic diagram of a Packet Data Convergence Protocol (PDCP) packet data unit (PDU) format according to an embodiment of the present disclosure. Note that, as an example, a unit in FIG. 1 is one bit. The PDCP PDU format shown in FIG. 1 comprises 12 bits PDCP serial number (SN), a Time Stamp field and a Time Stamp identification (TI) field.

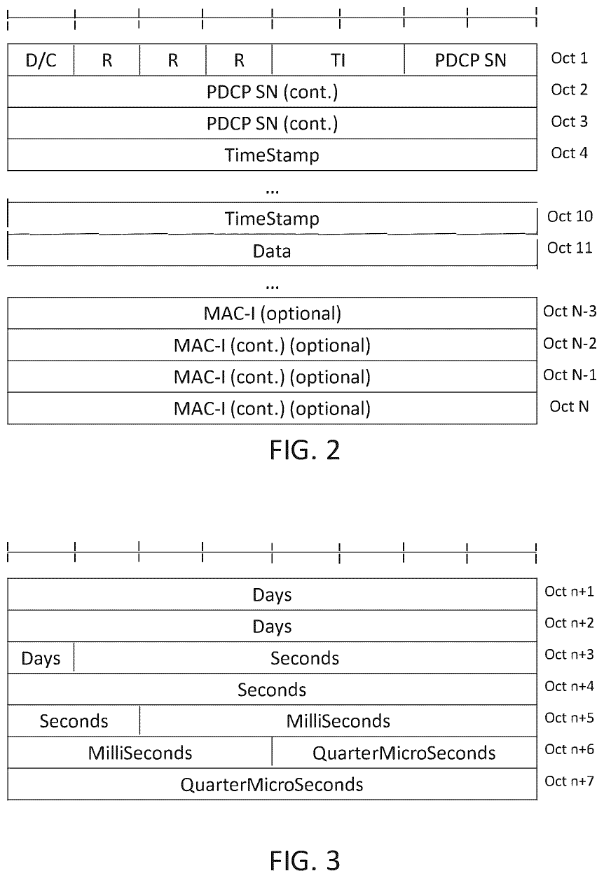

FIG. 2 shows a schematic diagram of a PDCP PDU format according to an embodiment of the present disclosure. The PDCP PDU format shown in FIG. 2 comprises 18 bits PDCP SN, a Time Stamp field and a TI field.

In the present disclosure, the Time Stamp field indicates time information for the per packet delay determination and the TI field indicates a time information identification of the time information.

In an embodiment of a downlink (DL) PDCP PDU, the TI field can be used to indicate a user plane function (UPF) time or a gNB time. For example, the TI field may be defined as:

| Value | Description |
|---|---|
| 00 | The Time Stamp field is not included |
| 01 | The Time Stamp field indicates the time |
| | of UPF sending DL data PDU |
| 10 | The Time Stamp field indicates the time |
| | of UPF receiving DL data PDU |
| 11 | The Time Stamp field indicates the time of |
| | gNB PDCP entity receiving DL data PDU |

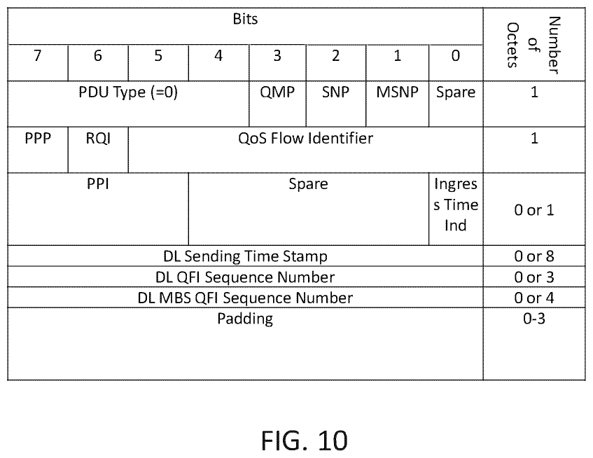

In an embodiment, if the TI field is set to 01, the Time Stamp field is set based on a value of a DL Sending Time Stamp in a DL PDU SESSION INFORMATION (PDU Type 0) Format shown in FIG. 10.

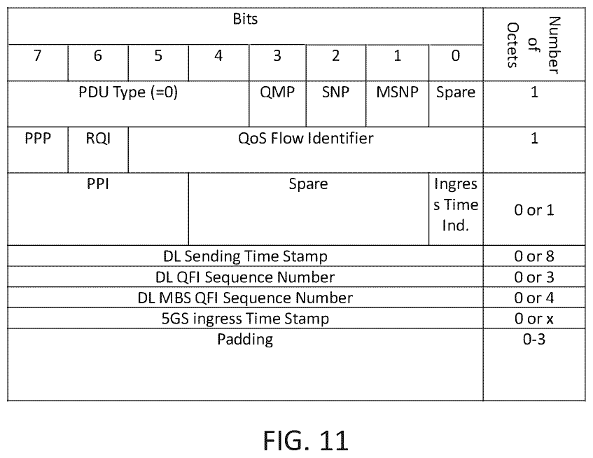

In an embodiment, if the TI field is set to 10, the Time Stamp field is set based on a value of DL Sending Time Stamp in the DL PDU SESSION INFORMATION (PDU Type 0) Format in FIG. 10 or a 5GS ingress time in DL PDU SESSION INFORMATION (PDU Type 0) Format in FIG. 11.

In an embodiment of an uplink (UL) PDCP PDU, the TI field may be used to indicate a UE time. For example, the TI field may be defined as:

| Value | Description |
|---|---|
| 00 | The Time Stamp field is not included |
| 01 | The Time Stamp field indicates the time of |
| | UE PDCP entity receiving UL data PDU |
| 10 | Reserved |
| 11 | Reserved |

Note that the above tables are examples for a TI value range and the descriptions of TI values may change for different scenarios.

In an embodiment, the Time Stamp and TI fields may be added in a radio link control (RLC) PDU header, to indicate delay information per packet between RLC entities. In this embodiment, the TI field may be used to indicate a packet arriving time or transmitting time at the RLC entity. For example, the TI field may be defined as:

| Value | Description |
|---|---|
| 00 | The Time Stamp field is not included |
| 01 | The Time Stamp field indicates the time of |
| | packet arriving at the transmitting RLC |
| | entity |
| 10 | The Time Stamp field indicates the time of |
| | packet transmitted from the transmitting |
| | RLC entity. |
| 11 | Reserved. |

Note that the above table exemplifies a TI value range and the descriptions of TI values may vary in different cases.

In an embodiment, the Time Stamp field may be/comprise 8 octets (Oct) (e.g. 8Bytes), e.g., as defined in Section 6 of IETF RFC 5905.

In an embodiment, the Time Stamp can be 7 Oct as shown in FIG. 3. FIG. 3 shows a schematic diagram of a Time Stamp format according to an embodiment of the present disclosure. In FIG. 3, the Time Stamp format is a 7 Oct (e.g. 7 Bytes) Time Stamp definition. For example, the Time Stamp format comprises:
a Days field consumes 17 bits and the value range is INTEGER (0 . . . 72999),
a Seconds field consumes 17 bits and the value range is INTEGER (0 . . . 86399),
a MilliSeconds field consumes 10 bits and the value range is INTEGER (0 . . . 999), and
a QuarterMicroSeconds field consumes 12 bits and the value range is INTEGER (0 . . . 3999).

The Time Stamp format in FIG. 3 indicates a time in a unit of 0.25 us from an origin to be refDays*86400*1000*4000+refSeconds*1000*4000+refMilliSeconds*4000+refQuarterMicroSeconds. The refDays field specifies the sequential number of days (with day count starting at 0) from the origin of the time field, e.g. 00:00:00 on the Gregorian calendar date 6 Jan. 1980 (start of GPS time) or a predefined start time point.

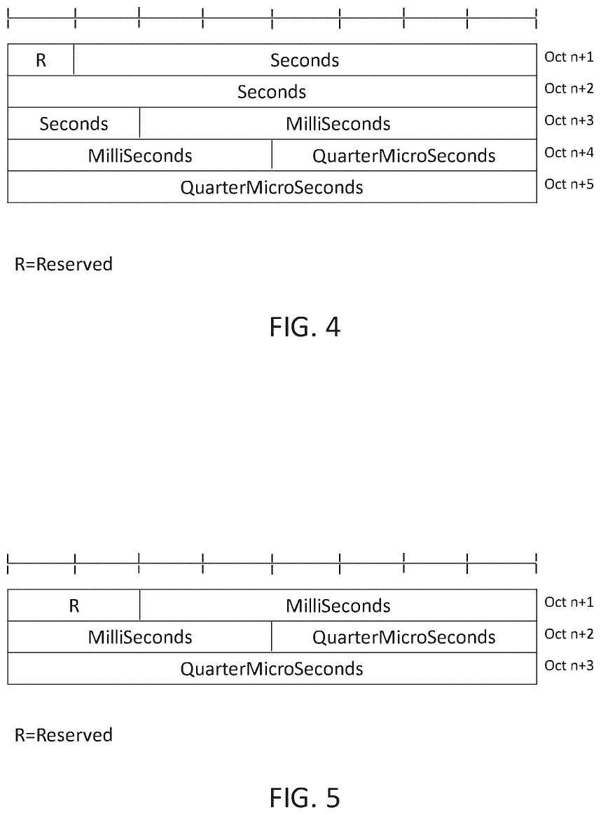

In an embodiment, the start time point may be defined as 00:00:00 of a day. In this embodiment, the day field shown in FIG. 3 may be removed. FIG. 4 shows a schematic diagram of a Time Stamp format according to an embodiment of the present disclosure. The Time Stamp format consumes 5 Oct (e.g. 5 Bytes) and indicates an elapsed time in a unit of 0.25 us from the 00:00:00 of the current day to be refSeconds*1000*4000+refMilliSeconds*4000+refQuarterMicroSeconds.

In an embodiment, the seconds field shown in FIG. 4 may be further omitted since the packet delay/latency may not be more than 1 second. In this embodiment, the start time point is defined as from the xx: yy: zz: 000, (i.e. 000 millisecond of current hour (xx), current minute (yy) and current second (zz) of the Day). FIG. 5 shows a schematic diagram of a Time Stamp format according to an embodiment of the present disclosure. The Time Stamp field shown in FIG. 5 consumes 3 Oct (e.g. 3 Bytes) and indicates an elapsed time in the unit of 0.25 us (i.e. microsecond) from the xx: yy: zz: 000 of the current day is to be refMilliSeconds*4000+refQuarterMicroSeconds.

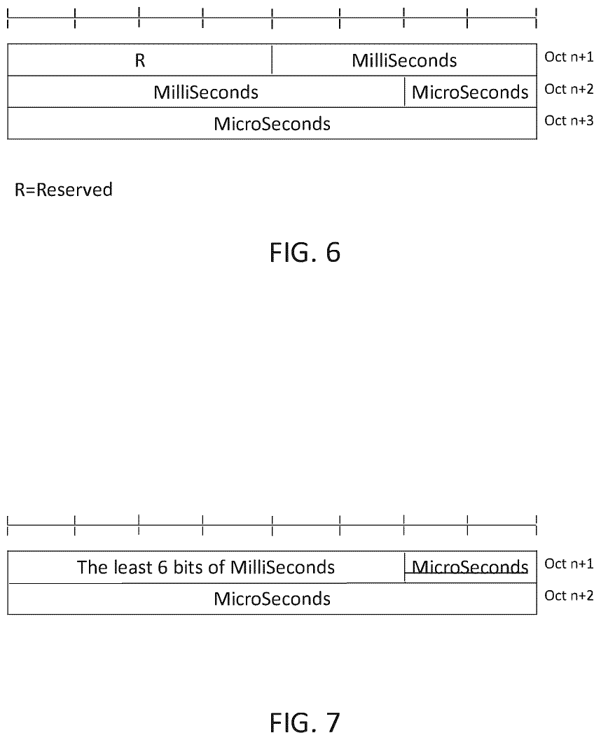

In an embodiment, the time unit may be changed from 0.25 μs to 1 μs and the quarterMicroSeconds can be changed to MicroSeconds. Under such conditions, 2 more bits can be saved. FIG. 6 shows a schematic diagram of a Time Stamp format according to an embodiment of the present disclosure. In FIG. 6, the start time point is defined as from the xx: yy: zz: 000 (e.g. 000 millisecond of current hour (xx), current minute (yy), and current second (zz) of the Day). The Time Stamp field consumes 3 Oct (e.g. 3 Bytes) and indicates an elapsed time in the unit of 1 μs from the xx: yy: zz: 000 of the current day to be refMilliSeconds*1000+MicroSeconds.

In an embodiment, the milliseconds field may be further compressed because the delay/latency may not be more than 20 milliseconds. For example, the least 6 bits of milliseconds field may be provided and the start time point is defined as from the xx: yy: zz: aaa (e.g. before and nearest integer times of 20 milliseconds of current hour (xx), current minute (yy), and current second (zz) of the Day. Under such conditions, the Time Stamp filed consumes 2 Oct (e.g. 2 Bytes) as shown in FIG. 7 and indicates an elapsed time in the unit of 1 μus from the xx: yy: zz: aaa of the current day to be refMilliSeconds*1000+refQuarterMicroSeconds, wherein xx is the current hour; yy is current minutes, zz is current seconds, aaa is floor (the current seconds/20), and floor () is a function of acquiring the maximum integer lower than the input variable of the function (e.g. the current seconds/20).

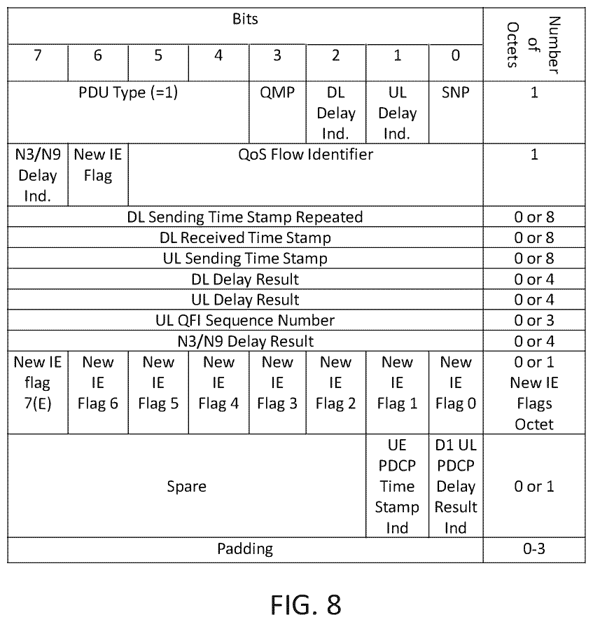

FIG. 8 shows a schematic diagram of a UL PDU SESSION INFORMATION (PDU Type 1) Format according to an embodiment of the present disclosure. The UL PDU SESSION INFORMATION (PDU Type 1) Format includes a UE PDCP Time Stamp indication (Ind.) filed which is transmitted from the gNB to the UPF. In FIG. 8, if the UE PDCP Time Stamp Ind. bit is set to “1”, the UL Sending Time Stamp indicates a time of the UE PDCP entity receiving the UL data SDU (e.g. the time of packet arriving at an upper service access point (SAP) of a PDCP entity, of the wireless terminal). For example, the UL Sending Time Stamp is set to the Time Stamp field value shown in FIG. 2.

In an embodiment of the Time Stamp field having 7 Oct in FIG. 3, the upper 7 Oct or the lower 7 Oct in the UL Sending Time Stamp of UL PDU SESSION INFORMATION (PDU Type 1) Format are used and the remaining 1 Oct is reserved.

In an embodiment of the Time Stamp field having 5 Oct shown in FIG. 4, the upper 5 Oct or the lower 5 Oct in the UL Sending Time Stamp of UL PDU SESSION INFORMATION (PDU Type 1) are used and the remaining 3 Oct are reserved. Note that, the Time Stamp field may be set as that shown in FIG. 5, 6 or 7. The remaining Oct in the UL Sending Time Stamp of UL PDU SESSION INFORMATION (PDU Type 1) are reserved.

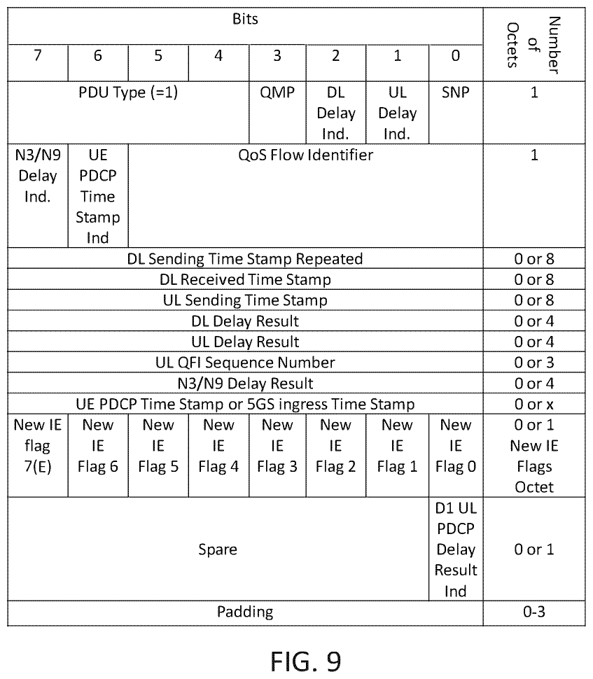

FIG. 9 shows a schematic diagram of a UL PDU SESSION INFORMATION (PDU Type 1) Format according to an embodiment of the present disclosure. The UL PDU SESSION INFORMATION (PDU Type 1) Format shown in FIG. 9 includes a UE PDCP Time Stamp Indication and UE PDCP Time Stamp (or 5GS ingress Time Stamp) field which is transmitted from the gNB to the UPF.

In FIG. 9, if the UE PDCP Time Stamp Ind. bit is set to “1”, the UE PDCP Time Stamp field is included to indicate the time of the UE PDCP entity receiving the UL data SDU (e.g. the time of packet arriving at an upper SAP of a PDCP entity of the wireless terminal). For instance, the UE PDCP Time Stamp field is set to the value of the Time Stamp field value shown in FIG. 2. In an embodiment, the UE PDCP Time Stamp field is x Oct (x Bytes) in an embodiment, where x equals the size of Time Stamp field shown in any of FIGS. 3 to 7 (i.e. 7 Oct, 5 Oct, 3 Oct, or 2 Oct).

FIG. 10 shows a schematic diagram of a DL PDU SESSION INFORMATION (PDU Type 0) Format with IngressTime Ind. according to an embodiment of the present disclosure. In FIG. 10, if the IngressTime Ind. bit is set to “1”, the DL Sending Time Stamp indicates the time of the UPF receiving the DL data PDU.

FIG. 11 shows a schematic diagram of a DL PDU SESSION INFORMATION (PDU Type 0) Format according to an embodiment of the present disclosure. In FIG. 11, the DL PDU SESSION INFORMATION (PDU Type 0) Format comprises an IngressTime Ind. and 5GS ingress Time Stamp. If the IngressTime Ind. bit is set to “1”, the 5GS ingress Time Stamp is included to indicate the time of the UPF receiving the DL data PDU.

In an embodiment, the 5GS ingress Time Stamp field is x Oct (x Bytes), where x equal to the size of Time Stamp field shown in any of FIGS. 3 to 7 (i.e., 7 Oct, 5 Oct, 3 Oct, or 2 Oct).

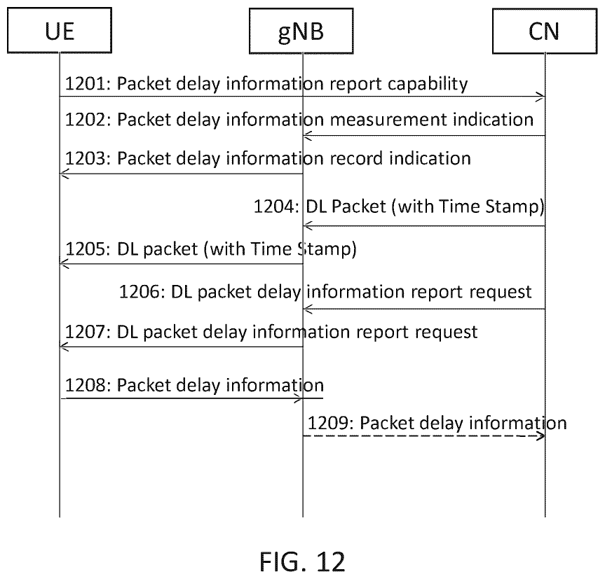

FIG. 12 shows a schematic diagram of a DL packet report procedure from the UE to a core network (CN) according to an embodiment of the present disclosure. In FIG. 12, the UE reports a packet delay information report capability to the CN, wherein the packet delay information report capability includes at least one of the DL packet delay report capability, or Time Stamp support indication in PDCP header. The packet delay information report capability may be carried in ATTACH REQUEST, REGISTER REQUEST or TRACKING AREA UPDATE REQUEST message (step 1201).

In steps 1202 and 1203, if the UE supports the packet delay information report capability, a DL packet delay information measurement indication may be transmitted to the UE, wherein the DL packet delay information measurement indication may be sent by one of the following manner:
The packet delay information measurement indication is sent to UE by a NAS procedure/message: The CN may send a packet delay information record Indication to the UE.
The packet delay information measurement indication is sent to the gNB by a UE associated signaling and the gNB sends the packet delay information measurement indication to the UE by an RRC message. In this embodiment, the CN and/or the gNB sends the DL packet with a Time Stamp at which the DL packet is sending or arriving.

In steps 1205 and 1206, the CN and/or the gNB requests the UE to report the DL packet delay information, wherein the requested report type may be on-demand (e.g. reporting once if requested), periodic (e.g. reporting with a periodicity), or event-based (e.g. reporting when the DL packet delay is larger than a predefined threshold). The reported DL packet delay information may be one of the following: a packet delay list of the all or recent X (X being a positive integer) received DL packet(s), the minimal DL packet delay, the maximal packet delay, an average packet delay, a DL packet delay of a received DL packet, a DL data transmission time information of a received DL packet set by the wireless network node, and/or a time information of the received DL packet arriving at the wireless network node.

In an embodiment, the request may be sent with the DL packet delay information measurement indication or sent by an independent message.

In step(s) 1208 (and 1209), the UE sends packet delay information (e.g. the DL packet delay) to the gNB by an RRC message based on the request from the gNB. As an alternative or in addition, the UE sends the DL packet delay to the CN by a NAS message based on the request from the CN. As a further alternative or in addition, the UE sends the DL packet delay to the gNB by an RRC message and the gNB sends the received DL packet delay to the CN by using a UE associated signaling based on the request from the CN.

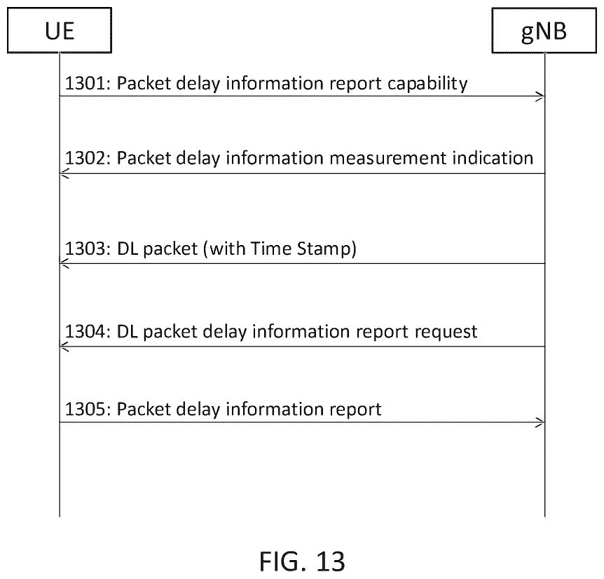

FIG. 13 shows a schematic diagram of a DL packet report procedure from the UE to the gNB according to an embodiment of the present disclosure. In FIG. 13, the UE reports a packet delay information report capability to the gNB, wherein the packet delay information report capability includes at least one of the DL packet delay report capability, or Time Stamp support indication in the PDCP header. In an embodiment, the packet delay information report capability can be carried in a UECapabilityInformation message (step 1301).

If the UE supports the packet delay information report capability, the gNB may send a DL packet delay information measurement indication to the UE by an RRC message (step 1302).

In step 1303, the gNB sends the DL packet with Time Stamp of the DL packet being sent from the PDCP entity or arriving at the PDCP entity.

In step 1304, the gNB requests the UE to report the DL packet delay, wherein the requested report type may be on-demand (e.g. reporting once if requested), periodic (reporting with a periodicity), or event (reporting when the delay is larger than a predefined threshold). The reported DL packet delay may be one of the: a packet delay list of the all or recent X (X being a positive integer) received DL packet(s), the minimal DL packet delay, the maximal packet delay, and/or the average packet delay, a DL packet delay of a received DL packet, a DL data transmission time information of a received DL packet set by the wireless network node, and/or a time information of the received DL packet arriving at the wireless network node.

In an embodiment, the request may be sent with the DL packet delay information measurement indication or by an independent message.

In step 1305, the UE sends the DL packet delay information by an RRC message based on the request from the gNB.

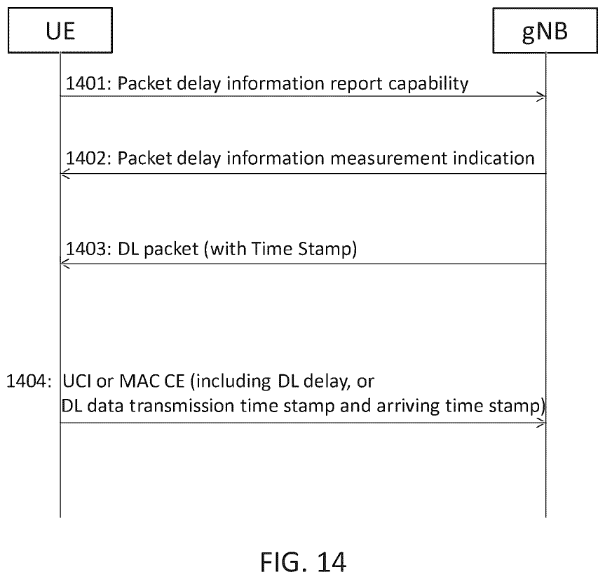

FIG. 14 shows a schematic diagram of a DL packet report procedure from the UE to the gNB according to another embodiment of the present disclosure. In FIG. 14, the UE reports the packet delay information report capability to the gNB, wherein the packet delay information report capability includes at least one of the DL packet delay report capability, Time Stamp support indication in PDCP header. Note that the packet delay information report capability may be carried in the UECapability Information message (step 1401).

If the UE supports the packet delay information report capability, the gNB sends a DL packet delay information measurement indication to UE by an RRC message (step 1402).

The gNB sends the DL packet with a Time Stamp of the DL packet being sent from the PDCP entity or arriving at the PDCP entity (step 1403).

In step 1404, the UE sends at least one of the following information by uplink control information (UCI) or MAC CE in response to the reception of the DL packet with the Time Stamp: the DL packet delay, DL data transmission Time Stamp set by gNB and the Time Stamp that the DL data arrives at the gNB.

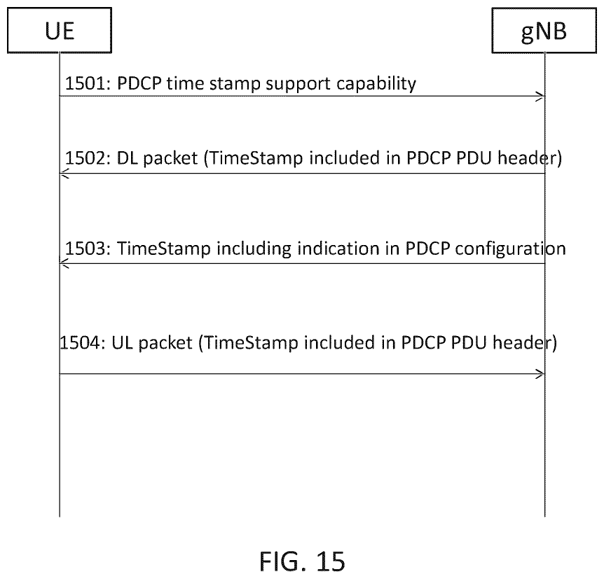

FIG. 15 shows a schematic diagram of a UL packet report procedure between the UE and the gNB according to an embodiment of the present disclosure. In FIG. 15, the UE reports the PDCP Time Stamp field support capability to the gNB (step 1501).

If the UE supports the PDCP Time Stamp field, the gNB may include the Time Stamp field in the DL PDCP PDU header (step 1502).

If the UE supports the PDCP Time Stamp field, the gNB may send a Time Stamp including indication to UE in PDCP configuration by an RRC message (step 1503).

In response to the reception of the Time Stamp including indication in the PDCP configuration, the UE includes the Time Stamp field in a UL PDCP PDU header (step 1504).

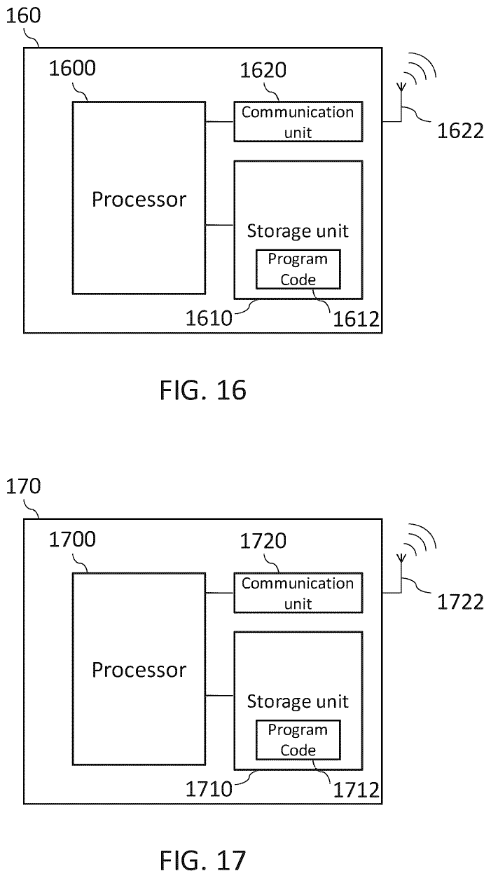

FIG. 16 relates to a schematic diagram of a wireless terminal 160 according to an embodiment of the present disclosure. The wireless terminal 160 may be a user equipment (UE), a mobile phone, a laptop, a tablet computer, an electronic book or a portable computer system and is not limited herein. The wireless terminal 160 may include a processor 1600 such as a microprocessor or Application Specific Integrated Circuit (ASIC), a storage unit 1610 and a communication unit 1620. The storage unit 1610 may be any data storage device that stores a program code 1612, which is accessed and executed by the processor 1600. Embodiments of the storage unit 1610 include but are not limited to a subscriber identity module (SIM), read-only memory (ROM), flash memory, random-access memory (RAM), hard-disk, and optical data storage device. The communication unit 1620 may a transceiver and is used to transmit and receive signals (e.g. messages or packets) according to processing results of the processor 1600. In an embodiment, the communication unit 1620 transmits and receives the signals via at least one antenna 1622 shown in FIG. 16.

In an embodiment, the storage unit 1610 and the program code 1612 may be omitted and the processor 1600 may include a storage unit with stored program code.

The processor 1600 may implement any one of the steps in exemplified embodiments on the wireless terminal 160, e.g., by executing the program code 1612.

The communication unit 1620 may be a transceiver. The communication unit 1620 may as an alternative or in addition be combining a transmitting unit and a receiving unit configured to transmit and to receive, respectively, signals to and from a wireless network node (e.g. a base station).

FIG. 17 relates to a schematic diagram of a wireless network node 170 according to an embodiment of the present disclosure. The wireless network node 170 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 170 may comprise (perform) at least one network function such as an access and mobility management function (AMF), a session management function (SMF), a user place function (UPF), a policy control function (PCF), an application function (AF), etc. The wireless network node 170 may include a processor 1700 such as a microprocessor or ASIC, a storage unit 1710 and a communication unit 1720. The storage unit 1710 may be any data storage device that stores a program code 1712, which is accessed and executed by the processor 1700. Examples of the storage unit 1710 include but are not limited to a SIM, ROM, flash memory, RAM, hard-disk, and optical data storage device. The communication unit 1720 may be a transceiver and is used to transmit and receive signals (e.g. messages or packets) according to processing results of the processor 1700. In an example, the communication unit 1720 transmits and receives the signals via at least one antenna 1722 shown in FIG. 17.

In an embodiment, the storage unit 1710 and the program code 1712 may be omitted. The processor 1700 may include a storage unit with stored program code.

The processor 1700 may implement any steps described in exemplified embodiments on the wireless network node 170, e.g., via executing the program code 1712.

The communication unit 1720 may be a transceiver. The communication unit 1720 may as an alternative or in addition be combining a transmitting unit and a receiving unit configured to transmit and to receive, respectively, signals to and from a wireless terminal (e.g. a user equipment or another wireless network node).

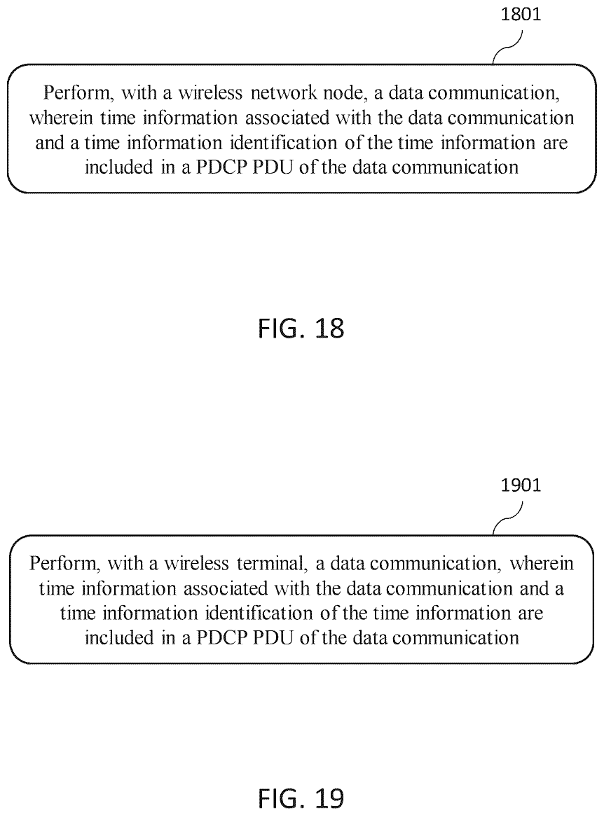

FIG. 18 shows a flowchart of a method according to an embodiment of the present disclosure. The method shown in FIG. 18 may be used in a wireless terminal (e.g. UE) and comprises the following step:
Step 1801: Perform, with a wireless network node, a data communication, wherein time information associated with the data communication and a time information identification of the time information are included in a PDCP PDU of the data communication.

In FIG. 18, the wireless terminal performs a data communication (e.g. transmission and/or reception) with a wireless network node (e.g. BS, gNB or RAN (node)). For the per packet delay (information) determination between the wireless network node and the wireless terminal, time information associated with the data communication (e.g. Time Stamp field) and a time information identification of the time information (e.g. TI field) are included in a PDCP PDU of the data transmission. For example, the time information and the time information identification are included in a PDCP PDU header of the PDCP PDU.

In an embodiment, the wireless terminal performs the data communication by receiving the PDCP PDU from the wireless network node. In this embodiment, the time information identification indicates that the time information is a time of packet transmitting from a PDCP entity, a time of packet arriving at an upper SAP of a PDCP entity of the wireless network node, a time of packet arriving at a PDCP entity, a time of packet arrival at a 5GS ingress, or a time of packet arrival at a UPF.

In an embodiment, the wireless terminal performs the data communication by transmitting the PDCP PDU to the wireless network node. In this embodiment, the time information identification indicates that the time information is a time of the wireless terminal receiving the PDCP PDU.

In an embodiment, the time information indicates a time by comprising:
a coordinated universal time (UTC)
a global positioning system (GPS) time,
an elapsed time from a start of a day,
an elapsed time from a start of second of a reference time, or
an elapsed time from a start of millisecond of a reference time, wherein a unit of the milliseconds of the reference time is 20 milliseconds.

Note that the unit of the time may be one of quarter microsecond, microsecond, nanosecond or a multiple of nanosecond. Further details of this embodiment may be found in the embodiments shown in FIGS. 3 to 7.

In an embodiment, the wireless terminal reports/transmits a packet delay information report capability to the wireless network node and/or a CN (e.g. UPF and/or AMF). The packet delay information report capability comprises/indicates at least one of a DL packet delay report capability or a time information support indication in a PDCP header.

In an embodiment, the packet delay information report capability is in an ATTACH REQUEST, a REGISTER REQUEST or a TRACKING AREA UPDATE REQUEST message.

In an embodiment, the wireless terminal may receive a packet delay information measurement indication from the wireless network node and/or the CN. For example, the packet delay information measurement indication is received from a NAS message (from the CN) and/or in an RRC message from the wireless network node.

In an embodiment, the wireless terminal reports/transmits packet delay information to the wireless network node and/or the CN. For example, the packet delay information may be reported to the wireless network node in an RRC message and/or is reported to the core network in a NAS message. The packet delay information comprises at least one of:
a packet delay list comprising packet delays of received DL packets,
the minimum DL packet delay,
the maximal DL packet delay,
an average packet delay,
a DL packet delay of a received DL packet,
a DL data transmission time information of a received DL packet set by the wireless network node, or
a time information of the received DL packet arriving at the wireless network node.

In an embodiment, the wireless terminal receives a request of reporting packet delay information from the wireless network node and/or the CN. In this embodiment, the wireless terminal reports the pack delay information based on/in response to the request.

In an embodiment, the request indicates that the packet delay information is reported once in response to the request, reported periodically or reported if a condition is satisfied. For example, the condition may be “if a packet delay is greater than a threshold.”

FIG. 19 shows a flowchart of a method according to an embodiment of the present disclosure. The method shown in FIG. 19 may be used in a wireless network node (e.g. BS, gNB, RAN node) and comprises the following step:
Step 1901: Perform, with a wireless terminal, a data communication, wherein time information associated with the data communication and a time information identification of the time information are included in a PDCP PDU of the data communication.

In FIG. 19, the wireless network node performs a data communication with a wireless terminal (e.g. UE). In order to acquire/determine the per packet delay between the wireless network node and the wireless terminal, time information associated with the data communication (e.g. Time Stamp field) and a time information identification of the time information (e.g. TI field) are included in a PDCP PDU of the data transmission. For example, the time information and the time information identification are included in a PDCP PDU header of the PDCP PDU.

In an embodiment, the wireless network node performs the data communication by transmitting the PDCP PDU to the wireless terminal. In this embodiment, the time information identification indicates that the time information is a time of packet transmitting from a PDCP entity, a time of packet arriving at an upper SAP of a PDCP entity of the wireless network node, a time of packet arriving at a PDCP entity, a time of packet arrival at a 5GS ingress, or a time of packet arrival at a UPF.

In an embodiment, the wireless network node performs the data communication by receiving the PDCP PDU from the wireless terminal. In this embodiment, the time information identification indicates that the time information is a time of the wireless terminal receiving the PDCP PDU.

In an embodiment, the time information indicates a time by comprising:
a coordinated universal time (UTC)
a global positioning system (GPS) time,
an elapsed time from a start of a day,
an elapsed time from a start of second of a reference time, or
an elapsed time from a start of millisecond of a reference time, wherein a unit of the milliseconds of the reference time is 20 milliseconds.

Note that the unit of the time may be one of quarter microsecond, microsecond, nanosecond or a multiple of nanosecond. For further details of this embodiment, it may be referred to the embodiments shown in FIGS. 3 to 7.

In an embodiment, the wireless network node may report/transmit the time information and the time identification in a UL PDU SESSION INFORMATION Format to a CN (e.g. UPF and/or AMF). For example, the time information is indicated by a UL Sending Time information field, a UE PDCP Time information field or a 5GS ingress Time information field in the UL PDU SESSION INFORMATION Format, which is identified by the time information identification. For further details of this embodiment, it may be referred to the embodiments shown in FIGS. 8 and 9.

In an embodiment, the wireless network node receives the time information and the time information identification included in a DL PDU SESSION INFORMATION Format from a CN (e.g. UPF and/or AMF). The time information may be indicated by a DL Sending Time information field or a 5GS ingress Time information field in the DL PDU SESSION INFORMATION Format which is identified by the time information identification.

In an embodiment, the wireless network node receives a packet delay information report capability from the wireless terminal. The packet delay information report capability comprises/indicates at least one of a DL packet delay report capability or a time information support indication in a PDCP header. The wireless network node may report/transmit the packet delay information report capability of the wireless terminal to a CN (e.g. UPF and/or AMF).

In an embodiment, the wireless network node transmits a packet delay information measurement indication to the wireless terminal. The packet delay information measurement indication may be transmitted in an RRC message. In this embodiment, the wireless network node may receive the packet delay information measurement indication from a CN before transmitting the packet delay information measurement indication to the wireless terminal.

In an embodiment, the wireless network node receives packet delay information from the wireless terminal, e.g. in an RRC message. For example, the packet delay information comprises at least one of:
a packet delay list comprising packet delays of received DL packets,
the minimum DL packet delay,
the maximal DL packet delay,
an average packet delay,
a DL packet delay of a received DL packet,
a DL data transmission time information of a received DL packet set by the wireless network node, or
a time information of the received DL packet arriving at the wireless network node.

The wireless network node may report/transmit the received packet delay information to a CN.

In an embodiment, the wireless network node transmits a request of reporting packet delay information to the wireless terminal. The request may indicate that the packet delay information is reported once in response to the request, reported periodically or reported if a condition (e.g. whether a packet delay is greater than a threshold.) is satisfied. In this embodiment, the wireless network node may receive the request of reporting the packet delay information from a CN before transmitting the request of reporting the packet delay information to the wireless terminal.

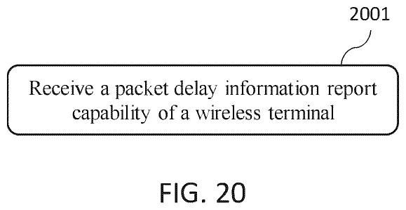

FIG. 20 shows a flowchart of a method according to an embodiment of the present disclosure. The method shown in FIG. 20 may be used in a CN (e.g. UPF and/or AMF) and may comprise the following step:
Step 2001: Receive a packet delay information report capability of a wireless terminal.

In this embodiment, the CN receives packet delay information report capability of a wireless terminal from the wireless terminal (e.g. UE) or a wireless network node (e.g. BS, gNB). The packet delay information report capability comprises at least one of a DL packet delay report capability or a time information support indication in a PDCP header. The packet delay information report capability may be in an ATTACH REQUEST, a REGISTER REQUEST or a TRACKING AREA UPDATE REQUEST message.

In an embodiment of the wireless terminal supports the packet delay information report and/or the time information support indication, the CN transmits DL packets with the time information and the time information identification to the wireless terminal (via the wireless network node) or the wireless network node. For example, the CN may transmit, to the wireless network node, the time information and the time information identification in a DL PDU SESSION INFORMATION Format. The time information is indicated by a UL Sending Time information field, a UE PDCP Time information field or a 5GS ingress Time information field in the UL PDU SESSION INFORMATION Format, which is identified by the time information identification.

In an embodiment, the CN transmits packet delay information measurement indication to the wireless terminal (via the wireless network node). The packet delay information measurement indication may be transmitted in a NAS message.

In an embodiment, the CN receives packet delay information (associated with the wireless terminal) from the wireless terminal or the wireless network node. The packet delay information may be in a NAS message. The packet delay information comprises at least one of:
a packet delay list comprising packet delays of received DL packets,
the minimum DL packet delay,
the maximal DL packet delay,
an average packet delay,
a DL packet delay of a received DL packet,
a DL data transmission time information of a received DL packet set by the wireless network node, or
a time information of the received DL packet arriving at the wireless network node.

In an embodiment, the CN transmits a request of reporting packet delay information to the wireless terminal (e.g. via the wireless network node). The request may indicate that the packet delay information is reported once in response to the request, reported periodically or reported if a condition (e.g. if a packet delay is greater than a threshold) is satisfied.

In an embodiment, the CN receives the time information and the time identification in a UL PDU SESSION INFORMATION Format. For example, the time information is indicated by a UL Sending Time information field, a UE PDCP Time information field or a 5GS ingress Time information field in the UL PDU SESSION INFORMATION Format, which is identified by the time information identification.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the method comprising:
performing, with a wireless network node, a data communication, wherein time information associated with the data communication and a time information identification of the time information are included in a Packet Data Convergence Protocol (PDCP) packet data unit (PDU) of the data communication.

2. The wireless communication method of claim 1, wherein the time information associated with the data communication and the time information identification of the time information are included in a PDCP PDU header of the PDCP PDU.

3. The wireless communication method of claim 1, wherein the performing, with the wireless network node, the data communication comprises: receiving, from the wireless network node, the PDCP PDU.

4. The wireless communication method of claim 3, wherein the time information identification indicates that the time information is a time of packet transmitting from a PDCP entity, a time of packet arriving at an upper service access point (SAP) of a PDCP entity of the wireless network node, a time of packet arriving at a PDCP entity, a time of packet arrival at a 5G system (5GS) ingress, or a time of packet arrival at a user plane function (UPF).

5. The wireless communication method of claim 1, wherein the performing, with the wireless network node, the data communication comprises: transmitting, to the wireless network node, the PDCP PDU.

6. The wireless communication method of claim 5, wherein the time information identification indicates that the time information is a time of the wireless terminal receiving the PDCP PDU.

7. The wireless communication method of claim 1, wherein the time information indicates a time by comprising: a coordinated universal time (UTC) a global positioning system (GPS) time, an elapsed time from a start of a day, an elapsed time from a start of a second of a reference time, or an elapsed time from a start of a millisecond of a reference time, wherein a unit of milliseconds of the reference time is 20 milliseconds, and wherein a unit of time is one of a quarter of a microsecond, a microsecond, a nanosecond, or a multiple of nanoseconds.

8. The wireless communication method of claim 1, further comprising: reporting, to the wireless network node or a core network, a packet delay information report capability.

9. The wireless communication method of claim 8, wherein the packet delay information report capability comprises at least one of a DL packet delay report capability or a time information support indication in a PDCP header.

10. A wireless communication method for use in a wireless network node, the method comprising:
performing, with a wireless terminal, a data communication, wherein time information associated with the data communication and a time information identification of the time information are included in a Packet Data Convergence Protocol (PDCP) packet data unit (PDU) of the data communication.

11. The wireless communication method of claim 10, wherein the time information associated with the data communication and the time information identification of the time information are included in a PDCP PDU header of the PDCP PDU.

12. The wireless communication method of claim 10, wherein the performing, with the wireless terminal, the data communication comprises: transmitting, to the wireless terminal, the PDCP PDU.

13. The wireless communication method of claim 12, wherein the time information identification indicates that the time information is a time of packet transmitting from a PDCP entity, a time of packet arriving at an upper service access point (SAP) of a PDCP entity, of the wireless network node, a time of packet arriving at a PDCP entity, a time of packet arrival at a 5G system (5GS) ingress, or a time of packet arriving at a user plane function (UPF).

14. The wireless communication method of claim 10, wherein the performing, with the wireless terminal, the data communication comprises:
receiving, from the wireless terminal, the PDCP PDU.

15. The wireless communication method of claim 14, wherein the time information identification indicates that the time information is a time of the wireless terminal receiving the PDCP PDU.

16. The wireless communication method of claim 10, wherein the time information indicates a time by comprising: a coordinated universal time (UTC) a global positioning system (GPS) time, an elapsed time from a start of a day, an elapsed time from a start of a second of a reference time, an elapsed time from a start of a millisecond of a reference time, wherein a unit of milliseconds of the reference time is 20 milliseconds, and wherein a unit of time is one of a quarter of a microsecond, a microsecond, a nanosecond, or a multiple of nanoseconds.

17. The wireless communication method of claim 10, further comprising:
reporting, to a core network, the time information and the time identification in an uplink, UL, PDU SESSION INFORMATION Format, wherein the time information is indicated by a UL Sending Time information field, a UE PDCP Time information field or a 5GS ingress Time information field in the UL PDU SESSION INFORMATION Format, and wherein the time information is identified by the time information identification.

18. The wireless communication method of claim 10, further comprising: receiving, from a core network, the time information and the time information identification included in a downlink (DL) PDU SESSION INFORMATION Format, wherein the time information is indicated by a DL Sending Time information field or a 5GS ingress Time information field in the DL PDU SESSION INFORMATION Format, and wherein the time information is identified by the time information identification.

19. A computer program product comprising a computer-readable program medium code stored thereupon, the code, when executed by at least one processor, causing the at least one processor to implement a wireless communication method comprising:
performing a data communication, wherein time information associated with the data communication and a time information identification of the time information are included in a Packet Data Convergence Protocol (PDCP) packet data unit (PDU) of the data communication.

20. The computer program product of claim 19, wherein the code, when executed by the at least one processor, causing the at least one processor to implement the wireless communication method further comprising:
reporting, to a wireless network node or a core network, a packet delay information report capability.
